(19) United States
(12) Patent Application Publication
(10) Pub. No.: US 2006/0098430 A1
(43) Pub. Date: May 11, 2006

(54) Flexible lighting method for a LED on a portable device

(75) Inventors: Chih-Ping Chang, Taipei City (TW); Shih-Chieh Chen, Taipei City (TW); Chien-Chung Chen, Taipei City (TW); Yueh-Chi Wang, Taipei City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: TATUNG CO., LTD., Taipei City (TW)

(21) Appl. No.: 11/250,489

(22) Filed: Oct. 17, 2005

(30) Foreign Application Priority Data
Nov. 10, 2004 (TW) 093134290

(51) Int. Cl. F21V 9/00

(52) U.S. Cl. 362/231

(57) ABSTRACT

The present invention relates to a flexible lighting method utilizing on a portable electronic device, which allows a color change for a LED of the portable device. In addition to allowing users to change the color displayed on the LED according to personal preference, the present invention can further detect the condition of the power supply device and display various colors to indicate each different condition of the power supply device, thus increasing the convenience during the course of the operation.

### BACKGROUND OF THE INVENTION

1. Field of the Invention

The present invention relates to a flexible lighting method and more particularly, to which a flexible lighting method for a LED on a portable device.

2. Description of Related Art

As technology advances rapidly in the field of electronics, sizes of all types of electronic devices, such as those PDAs or multimedia players, have been heading toward minimization. Such portable electronic devices not only can be carried around, they also possess either specific functions or tremendous computational ability; therefore they provide users a great amount of satisfaction in terms of recreation and convenience purposes, allowing users to be able to enjoy multimedia entertainment or access to word processing anywhere anytime.

A conventional LED lighting display method on a portable electronic device utilizes multiple LEDs, each being arranged in alignment and applied with different color, resulting in a color-changing effect as designed. Colors displayed from such LED lighting method have been predetermined before the final product is completed, thus the flexibility in the LED lighting display cannot be reached instantly by software controlling color change on the LED. This conventional method would more likely cause monotony during operations for users, resulting in loss of interests in using the product.

### SUMMARY OF THE INVENTION

The present invention discloses a flexible lighting display method that can be utilized on a portable electronic device, which includes steps as follows: (A) identifying all the colors configured to be shown on the portable electronic device; (B) executing normal condition color; (C) detecting whether the portable electronic device is going to execute a color change; (D) selecting from colors identified in the portable electronic device and changing to one of them when a color change is executed, or remaining with the color indicating normal condition otherwise; (E) detecting the condition of the power supply of the portable electronic device; and (F) changing the color shown subject to each corresponding condition of power supply when the condition of the power supply varies, or remaining with the color indicating normal condition otherwise.

The color display procedure mentioned above is executed via a LED in which it can be a lighting unit of a portable electronic device. Other than allowing users to change the color displayed on the LED according to personal preference, the present invention can further detect the condition of the power supply device and display various colors to indicate each different condition of the power supply device, thus increasing the convenience during the course of the operation.

### BRIEF DESCRIPTION OF THE DRAWINGS

FIG. 1a is a schematic drawing of an MP3 display related to the present invention.

FIG. 1b is a functional block diagram showing functions of an MP3 player related to the present invention.

FIG. 2 is a flow chart of a flexible lighting method of the present invention.

### DETAILED DESCRIPTION OF THE PREFERRED EMBODIMENT

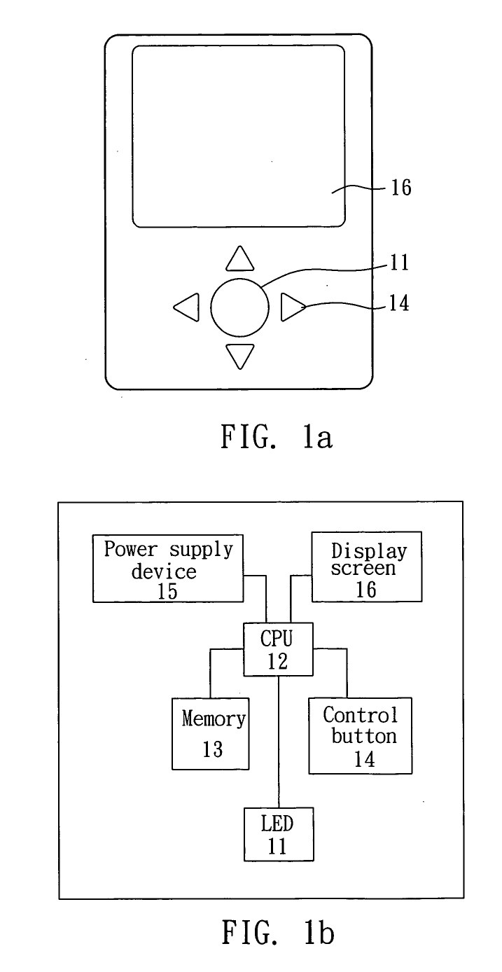

The present invention is a flexible lighting method which can be utilized on portable electronic devices. In this embodiment, the portable electronic device is an MP3 player 10. FIGS. 1a and 1b are the front view and the functional block diagrams of the MP3 player 10 respectively. The lighting method of the present invention is executed via a light emitting diode (LED) 11 and can be controlled by a control button 14 according to individual preferences. Selections of colors are displayed on the display screen 16 along with the information of the MP3 files being played.

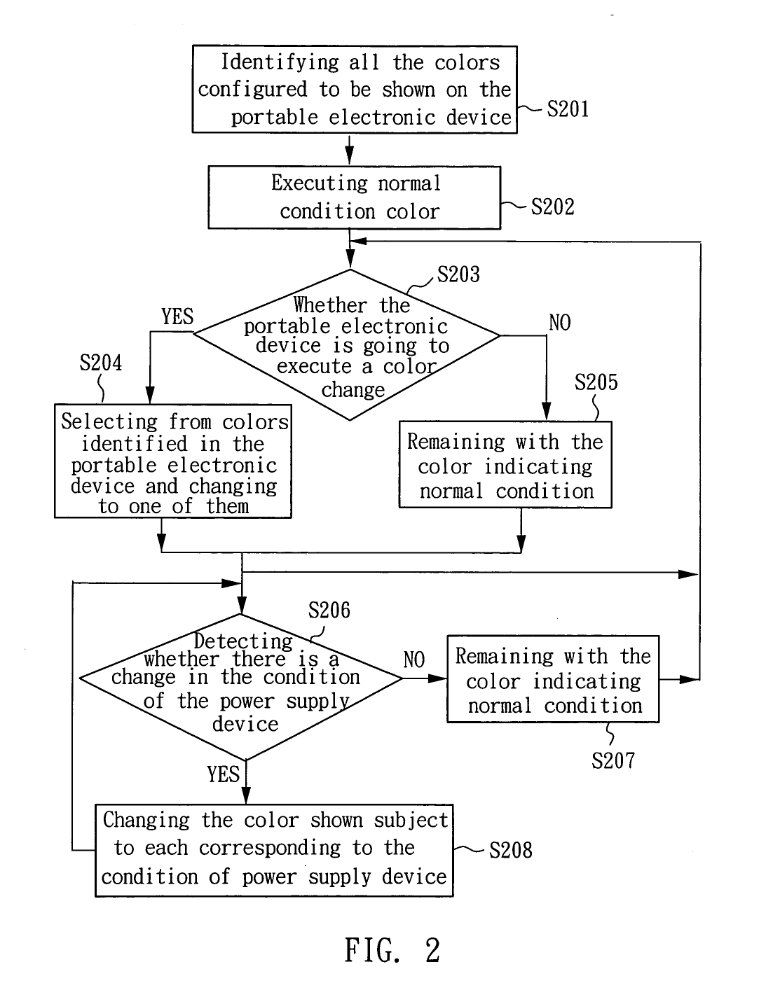

Regarding the lighting method of the present invention, please refer to the flow chart shown in FIG. 2. Firstly, in step S201 the user must save all the colors configured to be shown in the memory 13 of the MP3 player 10 and select one of the saved colors as the color indicating normal condition (step S202). When the MP3 player 10 is operating under normal circumstances, it will detect whether the user would like to adjust the color displayed through the LED 11 by using the control button 14 on the MP3 player 10 (step S203). When the central processor unit 12 of the MP3 player 10 receives a signal indicating a color change from the manipulation of the control button 14, the central processor unit 12 will then send the corresponding signal from the manipulation of the control button 14 to the LED 11, executing a color change (step S204). If the central processor unit 12 does not receive any signal indicating a color change, the color remains as configured originally; for example, if the LED displays blue light under normal condition at first, it will remain displaying the same.

The present invention not only can arbitrarily adjust the color displayed on the LED 11, but it can also detect the condition of the power supply device 15 of the MP3 player 10. In step S206, the MP3 player 10 is able to detect whether there is a change in the condition of the power supply device 15. If the condition of the power supply device 15 is under normal condition, the LED 11 on the portable device 10 remains as the color originally configured (step S207). If the condition of the power supply device 15 changes, the LED 11 will then change its color displayed accordingly to which each condition of the power supply device 15 corresponds (step S208). In this embodiment, when the power supply device 15 is under low power condition, the LED 11 displays a flashing red right; when the power supply device 15 is under charging condition, the LED 11 displays a flashing orange light; when the power supply device 15 is under full power condition, the LED 11 displays a solid white light.

Because the MP3 player 10 can change the color displayed on the LED 11 subject to an individual user's preference rather than displaying just one fixed color, it can avoid monotony and detect the change in the condition of the power supply device, in which it maximizes the convenience in use, thus satisfying the user's demand. Although the present invention has been explained in relation to its preferred embodiment, it is to be understood that many other possible modifications and variations can be made without departing from the spirit and scope of the invention as hereinafter claimed.

What is claimed is:

1. A flexible lighting method applied on a portable electronic device comprising the steps of:
(A) identifying all the colors configured to be shown on the portable electronic device;
(B) executing normal condition color;
(C) detecting whether the portable electronic device is going to execute a color change;
(D) selecting from colors identified in the portable electronic device and changing to one of them when a color change is executed, or remaining as the color indicating normal condition otherwise;
(E) detecting the condition of the power supply device of the portable electronic device; and
(F) changing the color shown subject to each corresponding the condition of power supply device when the condition of the power supply varies, or remaining with the color indicating normal condition otherwise.

2. The flexible lighting method as claimed in claim 1, wherein the lighting method is executed via a LED.

3. The flexible lighting method as claimed in claim 2, wherein the LED is mounted on an exterior case of the portable electronic device.

4. The flexible lighting method as claimed in claim 1, wherein the condition of the power supply comprises normal power condition, low power condition, charging condition, and full power condition.

5. The flexible lighting method as claimed in claim 4, wherein the normal power condition is indicated by default-colored light without undergoing any color change.

6. The flexible lighting method as claimed in claim 4, wherein the low power condition is indicated by flashing red light.

7. The flexible lighting method as claimed in claim 4, wherein the charging condition is indicated by flashing orange light.

8. The flexible lighting method as claimed in claim 4, wherein the full power condition is indicated by solid white light.
